(19) United States
(12) Patent Application Publication
(10) Pub. No.: US 2007/0268435 A1
(43) Pub. Date: Nov. 22, 2007

(54) Multi-domain vertically aligned liquid crystal display device

(75) Inventors: Chien-Chung Kuo, Feng Yuan City (TW); Chin-Chang Liu, Feng Yuan City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/634,294

(22) Filed: Dec. 6, 2006

(30) Foreign Application Priority Data
May 19, 2006 (TW) 095208587

(51) Int. Cl. G02F 1/1337; G02F 1/1343

(52) U.S. Cl. 349/129; 349/38

(57) ABSTRACT

A multi-domain vertically aligned liquid crystal display device includes a first substrate, a second substrate, and a liquid crystal layer interposed between the first substrate and the second substrate. The first substrate is provided with a plurality of gate lines, data lines and storage capacitor electrodes. Each pixel region of the display device is provided with at least one storage capacitor line, and the protrusion structure is formed to overlap the gate lines, the data lines, and the storage capacitor lines in each pixel region.

### BACKGROUND OF THE INVENTION

(a) Field of the Invention

The invention relates to a multi-domain vertically aligned liquid crystal display (MVA LCD) device having a high aperture ratio.

(b) Description of the Related Art

Nowadays, a vertically aligned (VA) mode liquid crystal display (LCD) is widely used since it provides a much higher contrast than the twisted nematic (TN) mode and is superior to the TN mode in terms of viewing angle characteristic.

FIG. 1 shows a plan view illustrating a conventional vertically aligned LCD 100, and FIG. 2 shows a cross-sectional view of the vertically aligned LCD, taken along line A-A′.

Referring to FIG. 1, a plurality of gate lines 102 are arranged extending in the lateral direction, and a plurality of data lines 104 are arranged extending in the lengthwise direction, with each two adjacent gate lines 102 intersected with two adjacent data lines 104 to define a pixel region on which a pixel electrode 108 is formed. Further, a storage capacitor line 106 is formed extending in the lateral direction between two adjacent gates lines 102. In the pixel region, first sequences of protrusions 112 and second sequences of protrusions 114 are formed in a zigzag manner, and each corner of each sequence of protrusions overlap the gate line 102 or the storage capacitor line 106. The first sequences of protrusions 112 are formed at regular intervals along the lateral direction, and each second sequence of protrusions 114 are provided between two adjacent first sequences of protrusions 112 and stretch in a like manner as the first one.

Referring to FIG. 2, the first and second sequences of protrusions 112 and 114 are respectively provided on an array substrate 110 and a color filter substrate 120. A vertical alignment film 116 is formed overlying the protrusions, and a liquid crystal layer 118 having negative dielectric anisotropy is interposed between the array substrate 110 and the color filter substrate 120. When no voltage is applied, the liquid crystal molecules 122 near the inclined surfaces orientate vertically to the inclined surfaces to have different degrees of tilt angles. In case the tilted liquid crystal molecules exist, surrounding liquid crystal molecules are tilted in the directions of the pre-tilt liquid crystal molecules when a voltage is applied. Thus, the orientation of the liquid crystal molecules within a unit pixel is divided into four mutually different directions, because each sequence of protrusions provide two different inclined surfaces and are bent to proceed in two mutually perpendicular directions.

However, though the zigzagged sequences of protrusions may regulate the orientation of liquid crystal molecules to define multiple domains, their zigzag distribution on pixel regions may occupy too much active display areas (light-transmitting areas) of an array substrate to considerably decrease the aperture ratio for a VA mode liquid crystal display.

### BRIEF SUMMARY OF THE INVENTION

Hence, an object of the invention is to provide a multi-domain vertically aligned liquid crystal display device having a high aperture ratio.

According to the invention, a multi-domain vertically aligned liquid crystal display device includes a first substrate, a second substrate, and a liquid crystal layer interposed between the first and the second substrates. The first substrate is provided with a plurality of gate lines, data lines and storage capacitor electrodes, where each two adjacent gate lines are intersected with two adjacent data lines to define a pixel region, and each pixel region is provided with at least one storage capacitor electrode. The second substrate faces the first substrate and is provided with a common electrode. A protrusion structure is formed to overlap the gate lines, the data lines, and the storage capacitor electrode in each pixel region. The protrusion structure may include multiple strip-shaped protrusion sections, and the storage capacitor electrode may be line-shaped.

Through the design of the invention, a large part of the protrusion structures for regulating the orientation of liquid crystal molecules are formed overlapping the gate lines, the data lines and the storage capacitor lines, which are made from opaque metallic films and naturally constitute the non-active display areas (non light-transmitting areas) of an array substrate. Hence, since a large part of the protrusion structures are placed in the non-active display areas of an array substrate, a higher aperture ratio is obtained compared with the conventional zigzagged protrusion design.

### BRIEF DESCRIPTION OF THE DRAWINGS

FIG. 1 shows a plan view illustrating a conventional vertically aligned liquid crystal display, and FIG. 2 shows a cross-sectional view of the vertically aligned liquid crystal display, taken along line A-A′.

FIG. 3 shows a plan view illustrating a multi-domain vertically aligned liquid crystal display device according to an embodiment of the invention.

FIG. 4A shows a cross-sectional view illustrating the arrangement of the protrusion sections in the upper sub-region, taken along line B-B′ of FIG. 3.

FIG. 4B shows a cross-sectional view illustrating the arrangement of the protrusion sections in the lower sub-region, taken along line C-C′ of FIG. 3.

FIG. 5A shows a schematic view illustrating the slanting directions of liquid crystal molecules in the upper sub-region.

FIG. 5B shows a schematic view illustrating the slanting directions of liquid crystal molecules in the lower sub-region.

FIG. 6 shows a schematic plan view illustrating the slanting directions of liquid crystal molecules in a unit pixel according to the invention.

FIG. 7 shows a plan view illustrating an arrangement of multiple pixels according to the invention.

FIG. 8 shows a plan view illustrating another embodiment of the invention.

FIG. 9 shows a plan view illustrating another embodiment of the invention.

FIG. 10 shows a plan view illustrating another embodiment of the invention.

FIG. 11 shows a plan view illustrating another embodiment of the invention.

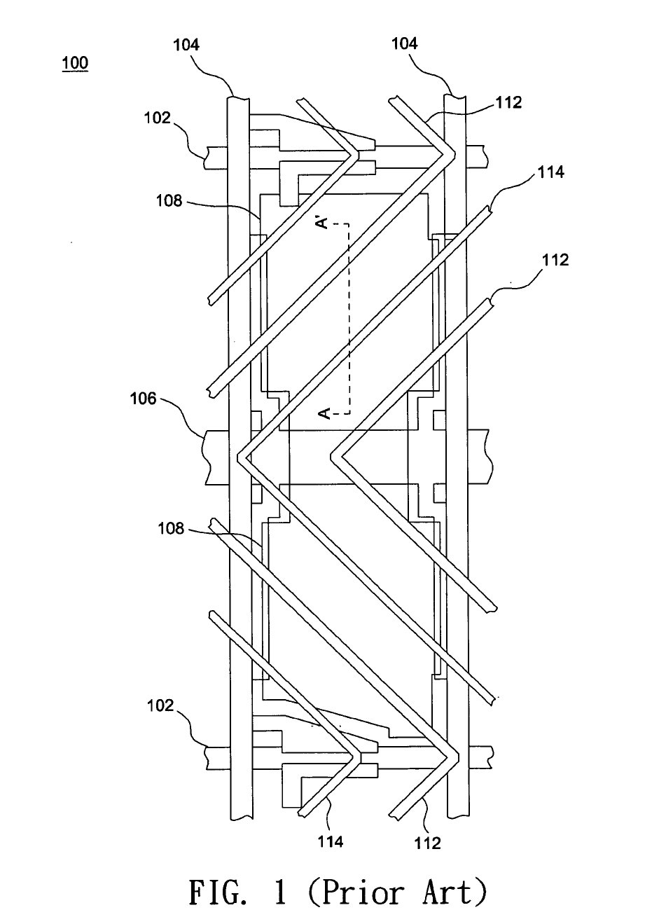

### DETAILED DESCRIPTION OF THE INVENTION

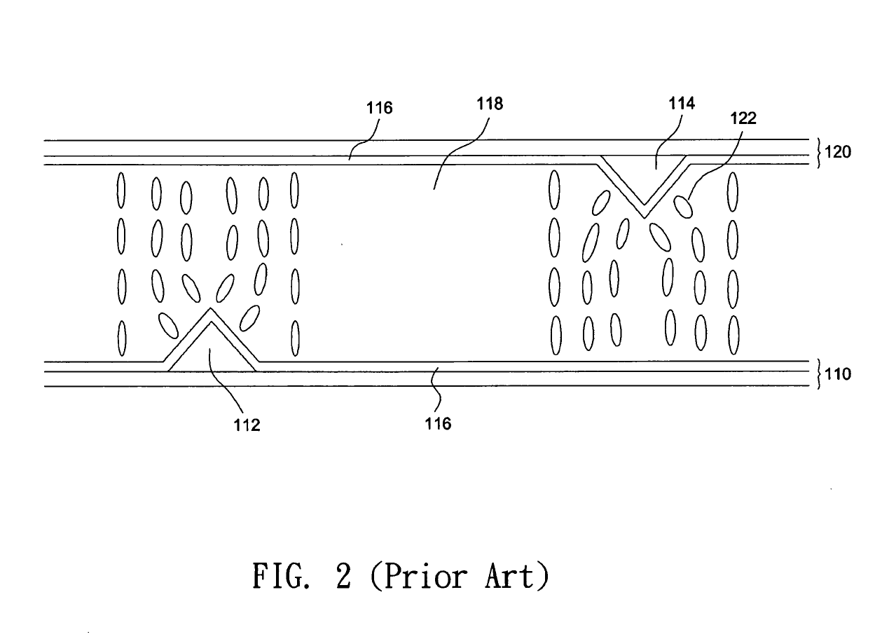

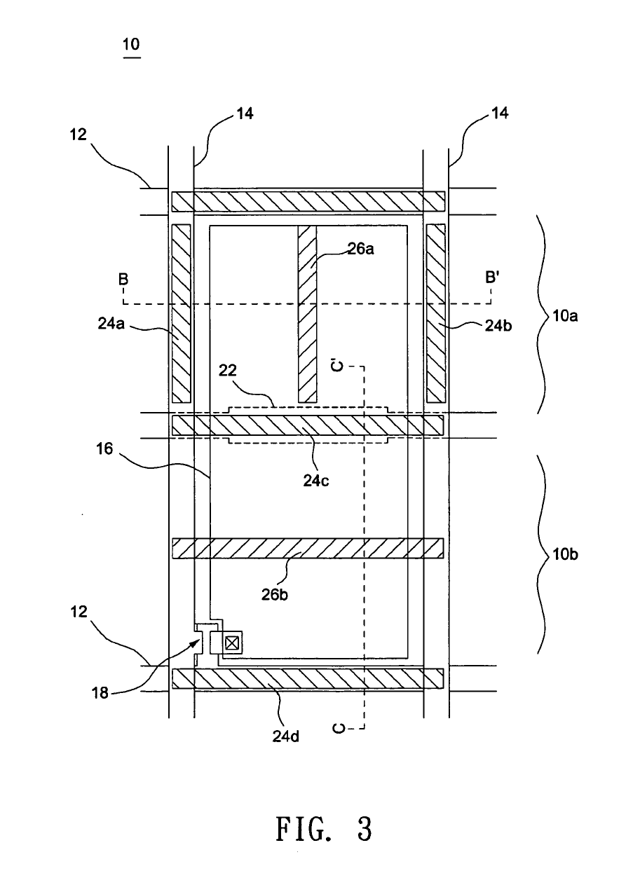

FIG. 3 shows a plan view illustrating a multi-domain vertically aligned liquid crystal display device 10 according to an embodiment of the invention.

Referring to FIG. 3, a plurality of gate lines 12 are arranged extending in the lateral direction, and a plurality of data lines 14 are arranged extending in the lengthwise direction, with each two adjacent gate lines 12 intersected with two adjacent data lines 14 to define a pixel region on which a pixel electrode 16 is formed. The pixel electrode 16 may be made from indium tin oxide (ITO) or indium zinc oxide (IZO) transparent conductive films, and a thin film transistor (TFT) 18 is formed in the vicinity of each intersection of the gate lines 12 and the data lines 14. Further, a line-shaped storage capacitor electrode 22 (hereinafter referred to as a storage capacitor line 22) is formed to extend in the lateral direction between two adjacent gates lines 12.

As shown in FIG. 3, the storage capacitor line 22 divides one pixel region into two parts, the upper sub-region 10a and the lower sub-region 10b. According to this embodiment, each pixel region is provided with a protrusion structure that includes a first protrusion 24 and a second protrusion 26. The first protrusion 24 including protrusion sections 24a, 24b, 24c and 24d is formed on an array substrate, and the second protrusion 26 including protrusion sections 26a and 26b is formed on a color filter substrate. The protrusion sections are strip-shaped and extend lengthwise or laterally in a unit pixel; in other words, the protrusions sections extend in a direction parallel to the gates lines 12 or the data lines 14. Note that each first protrusion 24 is indicated by slant hatched lines descending from upper-left to lower-right, and each second protrusion 26 is indicated by slant hatched lines descending from upper-right to lower-left.

In each first protrusion 24, the protrusion sections 24a and 24b extending in the lengthwise direction overlap the data lines 14, the protrusion section 24c extending in the lateral direction overlaps the storage capacitor line 22, and the protrusion section 24d extending in the lateral direction overlaps the gate line 12. In comparison, in each second protrusion 26, the protrusion section 26a extending in the lengthwise direction is provided in the middle of the upper sub-region 10a and between the protrusion sections 24a and 24b, and the protrusion section 26b extending in the lateral direction is provided in the middle of the lower sub-region 10b and between the protrusion sections 24c and 24d. The protrusion structure may be made from photoresist or polyimide resin.

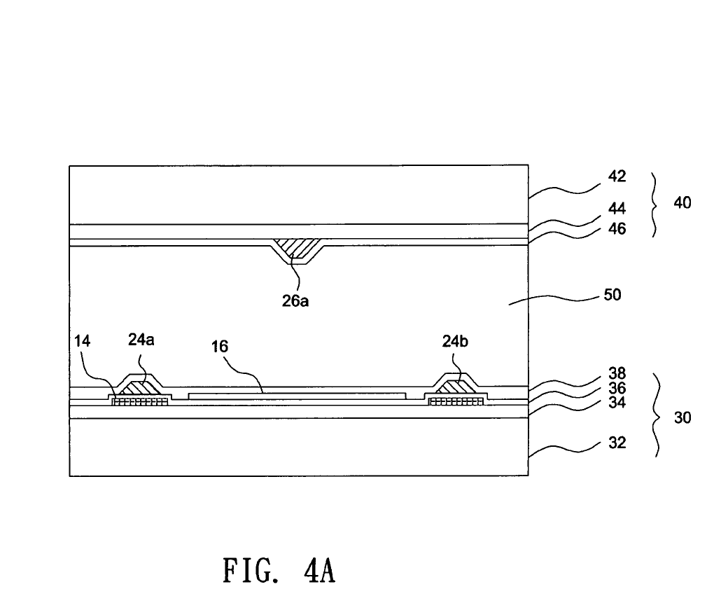

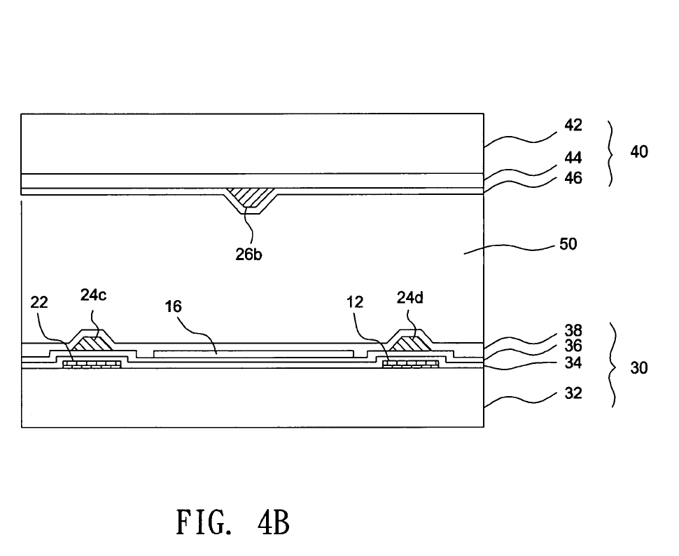

FIG. 4A shows a cross-sectional view illustrating the arrangement of the protrusion sections in the upper sub-region 10a, taken along line B-B′ of FIG. 3.

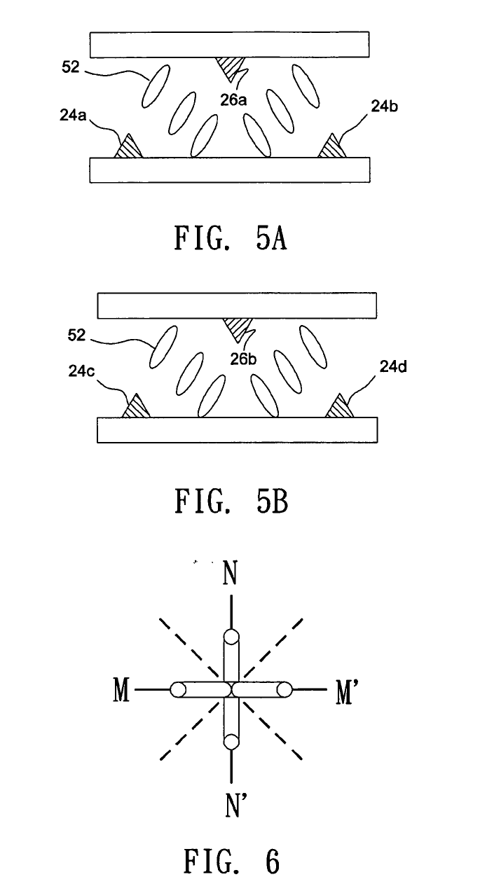

Referring to FIG. 4A, a dielectric gate insulation layer 34 is formed on the transparent substrate 32 of the array substrate 30, and the data lines 14 are formed on the gate insulation layer 34. A dielectric passivation layer 36 is formed overlying the gate insulation layer 34 and the data lines 14, and a pixel electrode 16 is formed on the passivation layer 36. A vertical alignment film 38 covers the lengthwise-extending protrusion sections 24a and 24b that overlap the data lines 14. Further, in the color filter substrate 40, a common electrode 44 is formed overlying an entire surface of a transparent substrate 42, and the lengthwise-extending protrusion section 26a is formed on the common electrode 44 and covered with a vertical alignment film 46. A liquid crystal layer 50 having negative dielectric anisotropy is interposed between the array substrate 30 and the color filter substrate 40. According to this embodiment, the lengthwise-extending protrusion sections 26a, 24a, and 24b divide the orientation of the liquid crystal molecules into azimuths that are mutually different; that is, the orientation of the liquid crystal molecules within the upper sub-region 10a is divided into two slanting directions, as shown in FIG. 5A.

FIG. 4B shows a cross-sectional view illustrating the arrangement of the protrusion sections in the lower sub-region 10b, taken along line C-C′ of FIG. 3.

Referring to FIG. 4B, the laterally-extending gate line 12 and the storage capacitor line 22 are formed on the transparent substrate 32 of the array substrate 30. The laterally-extending protrusion sections 24c and 24d, which are covered with a vertical alignment film 38, respectively overlap the storage capacitor line 22 and the gate line 12. The laterally-extending protrusion section 26b is formed on the common electrode 44 and covered with a vertical alignment film 46. According to this embodiment, the laterally-extending protrusion sections 26b, 24c, and 24d lengthwise divides the orientation of the liquid crystal molecules into azimuths that are mutually different; that is, the orientation of the liquid crystal molecules is divided into two slanting directions within the lower sub-region 10b, as shown in FIG. 5B. Note that the sectional views shown in FIG. 5A and FIG. 5B are obtained by cutting a liquid crystal cell along mutually perpendicular directions.

Hence, as seen in FIG. 6, the orientation of the liquid crystal molecules within the upper sub-region 10a is divided into two directions M and M′, and the orientation of the liquid crystal molecules within the lower sub-region 10b is divided into another two directions N and N′. Consequently, according to the design of the invention, the orientation of the liquid crystal molecules within a unit pixel can be divided into four mutually different directions; that is, a four-domain profile of a liquid crystal cell is created.

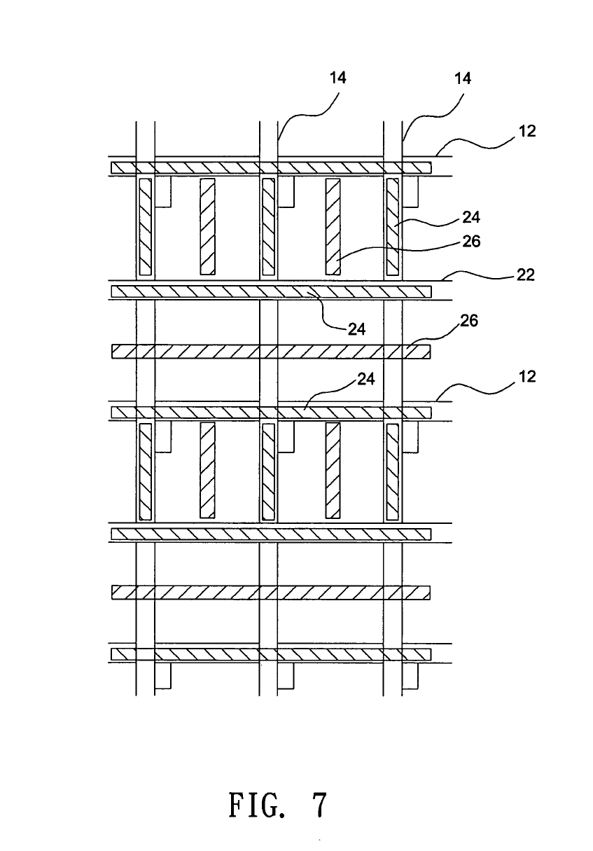

FIG. 7 shows a plan view illustrating an arrangement of multiple pixels according to the invention. Referring to FIG. 7, it is clearly seen most of the protrusion sections (i.e. the protrusion sections contained in the first protrusions 24) for regulating the orientation of liquid crystal molecules are formed overlapping the gate lines 12, the data lines 14, and the storage capacitor lines 22, which are all made from opaque metallic films and naturally constitute the non-active display areas (non light-transmitting areas) of an array substrate. Hence, since most of the protrusion sections are placed in the non-active display areas of an array substrate (the gap formed between two adjacent pixels and the occupied areas of the storage capacitor lines 22) according to the invention, a higher aperture ratio is obtained compared with the conventional zigzagged protrusion design.

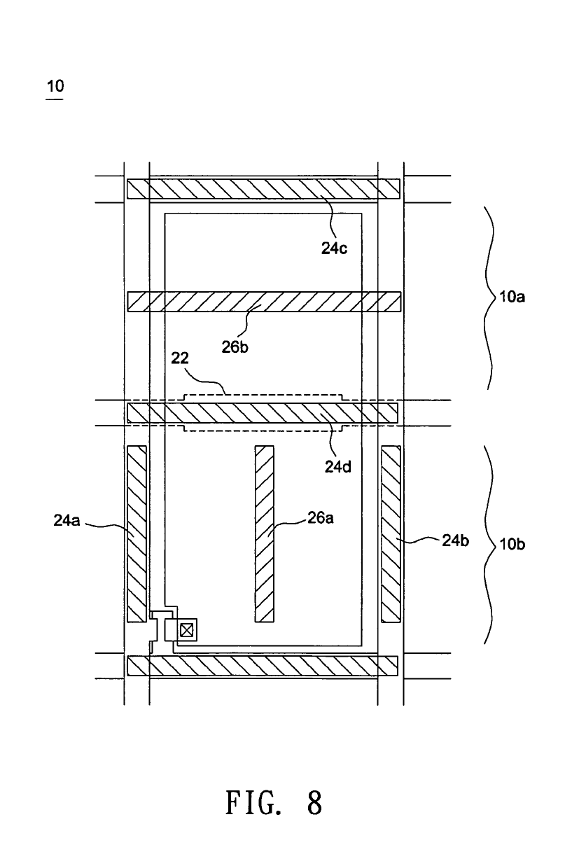

FIG. 8 shows a plan view illustrating another embodiment of the invention. Referring to FIG. 8, after the storage capacitor line 22 divides a pixel region into an upper sub-region 10a and a lower sub-region 10b, the three laterally-extending protrusion sections 26b, 24c, and 24d may be formed in the upper sub-region 10a, while the three lengthwise-extending protrusion sections 26a, 24a, and 24b may be formed in the lower sub-region 10b.

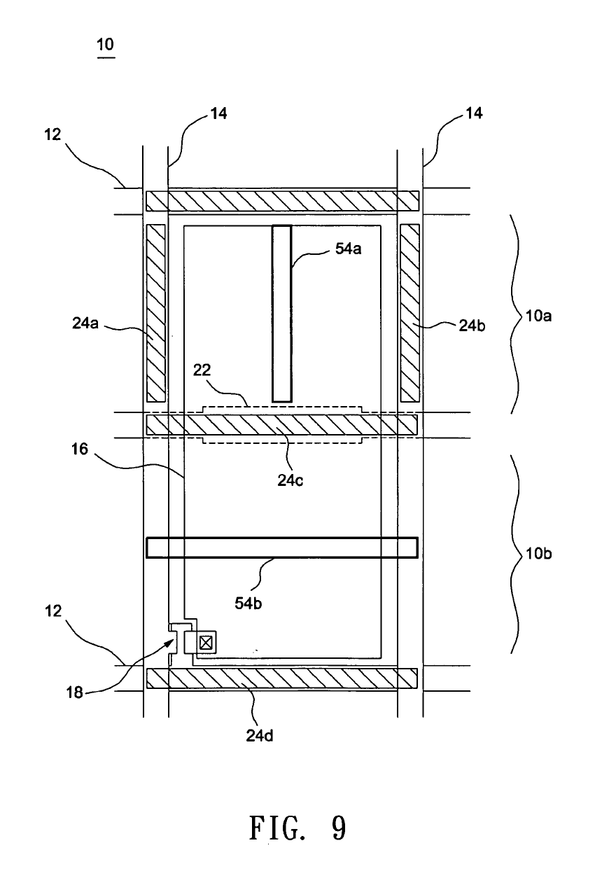

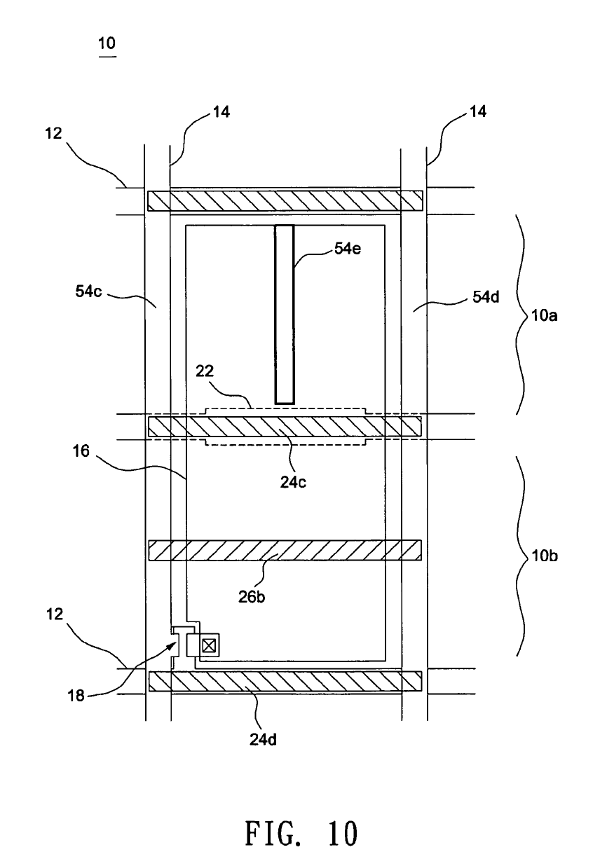

FIG. 9 shows a plan view illustrating another embodiment of the invention. According to this embodiment, the electrodes may be additionally provided with openings to induce fringe electrical fields, and the electrode openings and the protrusion structures may cooperate to regulate the orientation of liquid crystal molecules to create multiple domains. Referring to FIG. 9, for example, the openings 54a and 54b are provided instead of the protrusion sections 26a and 26b on the common electrode 44 shown in FIG. 4A to achieve the same effect of forming multiple domains. Further, the openings may be strip-shaped, as shown in FIG. 9.

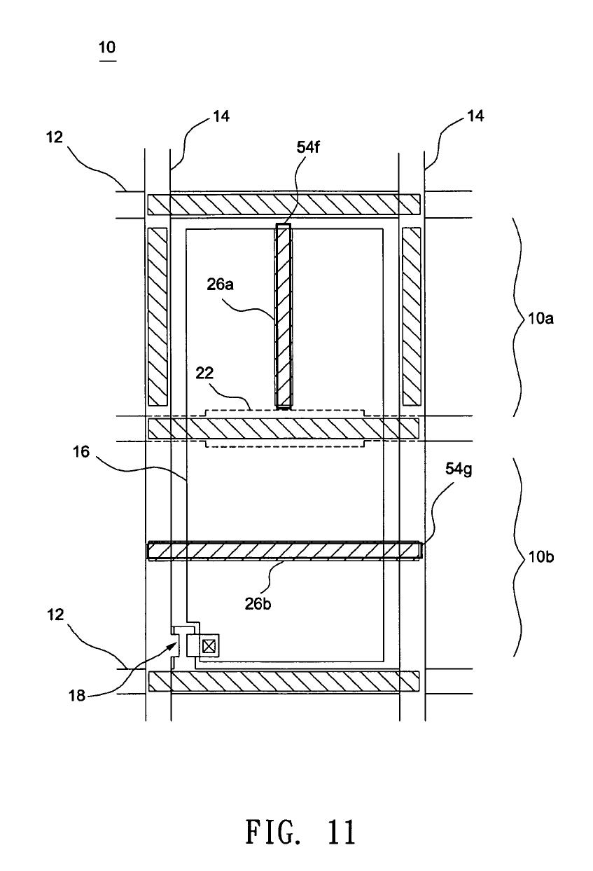

FIG. 10 shows a plan view illustrating another embodiment of the invention. During the fabrication of an array substrate, a gap is naturally formed between two pixels (i.e. between two adjacent pixel electrodes), such as the gap 54c or the gap 54d shown in FIG. 10, and the gaps 54c and 54d also allow to produce fringe electric fields. Thus, in this embodiment, the upper sub-region 10a is provided with only one opening 54e on the common electrode, and the opening 54e together with the pixel gaps 54c and 54d may replace the lengthwise-extending protrusions to achieve the same effect of forming multiple domains.

Alternatively, as shown in FIG. 11, the electrode openings 54f and 54g are additionally formed and overlap the protrusion sections 26a and 26b to further enhance the strength for slanting the liquid crystal molecules.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A multi-domain vertically aligned liquid crystal display device, comprising:
a first substrate provided with a plurality of gate lines, data lines and storage capacitor electrodes, wherein each two adjacent gate lines are intersected with two adjacent data lines to define a pixel region, and each pixel region is provided with at least one storage capacitor electrode;
a second substrate facing the first substrate and provided with a common electrode;
a liquid crystal layer having negative dielectric anisotropy interposed between the first substrate and the second substrate; and
a protrusion structure formed to overlap the gate lines, the data lines, and the storage capacitor electrode in each pixel region to regulate the orientation of liquid crystal molecules to create multiple domains.

2. The liquid crystal display device as claimed in claim 1, wherein the protrusion structure includes multiple strip-shaped protrusion sections, and the storage capacitor electrode is line-shaped.

3. The liquid crystal display device as claimed in claim 2, wherein the line-shaped storage capacitor electrode divides each pixel region into a first and a second sub-regions, the protrusion sections provided in the first sub-region are substantially parallel to the data lines and induce a first and a second slanting directions of liquid crystal molecules, and the protrusion sections provided in the second sub-region are substantially parallel to the gate lines and induce a third and a fourth slanting directions of liquid crystal molecules.

4. The liquid crystal display device as claimed in claim 1, wherein the protrusion structure is made from photoresist or polyimide resin.

5. The liquid crystal display device as claimed in claim 1, wherein the protrusion structure is formed on both of the first and the second substrates.

6. The liquid crystal display device as claimed in claim 5, wherein the storage capacitor electrode is line-shaped and substantially parallel to the gate lines to divide the pixel region into a first and a second sub-regions, and the orientation of the liquid crystal molecules in each sub-region is divided into two mutually different directions.

7. The liquid crystal display device as claimed in claim 6, wherein the protrusion structure includes three strip-shaped sections in the first sub-region substantially parallel to the data lines and three strip-shaped sections in the second sub-region substantially parallel to the gate lines.

8. The liquid crystal display device as claimed in claim 7, wherein the middle section of the three strip-shape sections is formed on the second substrate, and other two strip-shape sections are formed on the first substrate.

9. The liquid crystal display device as claimed in claim 1, wherein the common electrode is provided with openings.

10. The liquid crystal display device as claimed in claim 9, wherein the storage capacitor electrode is line-shaped and substantially parallel to the gate lines to divide the pixel region into a first and a second sub-regions, the protrusion structure is provided in the first sub-region to induce a first and a second slanting directions of liquid crystal molecules, and the openings are provided in the second sub-region to induce a third and a fourth slanting directions of liquid crystal molecules.

11. The liquid crystal display device as claimed in claim 9, wherein the protrusion structure includes multiple strip-shaped protrusion sections, and the openings are strip-shaped.

12. The liquid crystal display device as claimed in claim 11, wherein each strip-shaped opening is formed between two strip-shaped protrusion sections.

13. The liquid crystal display device as claimed in claim 9, wherein the openings are formed overlapping the protrusion structure.

14. A multi-domain vertically aligned liquid crystal display device, comprising:
a plurality of pixels, wherein each pixel is provided with at least one storage capacitor electrode and a gap is formed between two adjacent pixels; and
a plurality of protrusion structures formed to at least overlap each gap and each storage capacitor electrode to regulate the orientation of liquid crystal molecules to create multiple domains.

15. The liquid crystal display device as claimed in claim 14, wherein each protrusion structure includes multiple strip-shaped protrusion sections, and each storage capacitor electrode is line-shaped and divides each pixel into a first and second sub-regions.

16. The liquid crystal display device as claimed in claim 15, wherein the protrusion sections provided in the first sub-region are substantially parallel to the data lines and induce a first and a second slanting directions of liquid crystal molecules, and the protrusion sections provided in the second sub-region are substantially parallel to the gate lines and induce a third and a fourth slanting directions of liquid crystal molecules.

17. The liquid crystal display device as claimed in claim 14, wherein the common electrode is provided with openings.

18. The liquid crystal display device as claimed in claim 17, wherein the protrusion structure includes multiple strip-shaped protrusion sections, and the openings are strip-shaped.

19. The liquid crystal display device as claimed in claim 18, wherein each strip-shaped opening is formed between two strip-shaped protrusion sections.

20. The liquid crystal display device as claimed in claim 17, wherein the openings are formed overlapping the protrusion structure.
